(19) United States
(12) Patent Application Publication
(10) Pub. No.: US 2026/0264036 A1
(43) Pub. Date: Sep. 10, 2026

(54) ENERGY STORAGE

(71) Applicant: THE UNIVERSITY OF BIRMINGHAM, Birmingham (GB)

(72) Inventor: Yongliang LI, Birmingham (GB)

(21) Appl. No.: 19/168,103

(22) PCT Filed: Mar. 27, 2024
(86) PCT No.: PCT/GB2024/050841

§ 371 Date: Sep. 23, 2025

(30) Foreign Application Priority Data
Mar. 30, 2023 (GB) 2304743.4

(51) Int. Cl. B01J 8/02; B60H 1/32; B60L 1/00; B60L 1/02; B60L 50/64

(52) U.S. Cl. CPC B01J 8/0285; B01J 8/0278; B60H 1/32; B60L 1/003; B60L 50/64; B01J 2208/00256; B60L 1/02

(57) ABSTRACT

A mobile platform (C) comprising an energy storage system, the system comprising a sorbent and sorbate pair, the system further comprising a first chamber (11), a second chamber (13), a fluid flow conduit (12) fluidly connecting the first chamber (11) and the second chamber (13), and a microwave generator (21), wherein the microwave generator (21) is operable in use to desorb the sorbate from the sorbent in the first chamber (11) to release thermal energy from the second chamber (13), and wherein the second chamber (13) is thermally connectable to a source of fluid to condense the sorbate and thereby heat the fluid.

This invention relates generally to a system and method for storing energy. More specifically, although not exclusively, this invention relates to a system and method for thermochemical energy storage and release.

The world still heavily relies on fossil fuels for its energy consumption. Fossil fuels are both unsustainable and polluting to the environment, leading to climate change, which has become a significant concern. Renewable energy sources provide a valuable contribution to decarbonisation efforts. However, there is often a mismatch in terms of supply and demand at specific times of the day, with renewable energy sources often being unable to provide energy “on demand”. Therefore, there is a need for energy storage systems to address this supply-demand mismatch.

One of the biggest contributors towards emissions are vehicles, e.g. cars. Electric vehicles are increasingly being adopted in the UK, with the Local Government Association estimating that by 2030 there will be between approximately 8 million and 11 million hybrid or electric cars in the UK, if uptake is aligned with the Road to Zero (RTZ) targets. However, there remains a perception amongst the public that electric cars have insufficient range (so called “range anxiety”). Whilst this may be a problem of perception rather than fact it is well known that the range that an electric vehicle (EV) can travel once charged when operating in extreme environmental temperature conditions (hot or cold) is reduced in comparison to ambient temperatures. This is principally due to the fact that an EV has a single power source (the battery pack) which is required to provide power for locomotion and other on-board requirements. It is estimated that the energy supplied to the heating, ventilation, and air conditioning (HVAC) system can reduce the driving range of the EV by up to 34% in summer and up to 54% in winter.

Thermochemical energy storage is one type of energy storage solution. Energy is stored when thermal energy is used to drive an endothermic reaction. The reverse reaction is an exothermic process, which enables the release of thermal energy, thereby providing an energy storage and release system.

Traditional thermochemical storage systems are charged by applying thermal energy to the outside of a reaction vessel, which then has to reach the inside of the reaction vessel through heat conduction, resulting in a slow, inefficient (heat absorbed by the reactor walls), and mostly incomplete (due to a non-uniform temperature profile) charging process. In addition, traditional thermochemical storage systems can have long response times during discharge (e.g. 20 to 30 minutes to reach the desired temperature), which is unacceptable for many real world applications.

It is therefore a first non-exclusive object of the invention to provide an energy storage system, e.g. a battery, which mitigates or overcomes one or more of the aforementioned problems.

Accordingly, a first aspect of the invention provides a mobile platform comprising an energy storage system, the system comprising a sorbent and sorbate pair, the system further comprising a first chamber, a second chamber, a fluid flow conduit fluidly connecting the first chamber and the second chamber, and a microwave generator, wherein the microwave generator is operable in use to desorb the sorbate from the sorbent in the first chamber to release thermal energy from the second chamber, and wherein the second chamber may be thermally connectable to a source of fluid to condense the sorbate and thereby heat the fluid.

A second aspect of the invention provides an energy storage system, the system comprising a sorbent and sorbate pair, the system further comprising a first chamber, a second chamber, a fluid flow conduit fluidly connecting the first chamber and the second chamber and a microwave generator, wherein the microwave generator is operable in use to desorb the sorbate from the sorbent in the first chamber to release thermal energy from the second chamber, and wherein the second chamber is thermally connectable to a source of fluid to condense the sorbate and thereby heat fluid.

It will be appreciated that by running the system in reverse, that is by absorbing the sorbate on the sorbent the fluid may be cooled.

Advantageously, the use of a microwave generator in the system of the invention provides an instantaneous and fast charging process in comparison to the use of thermal energy. Moreover, the use of a microwave generator in the system of the invention provides a selective heating process, which is more efficient. This is because microwave energy is selectively absorbed by the desired components, and is not wasted by heating the reactor walls, for example. Additionally, microwave generators may be used over a wide temperature range, e.g. from 0 to 350° C., in the system of the invention.

The microwave energy is generated using electricity, which may be for example provided by waste or excess electricity during times of low demand.

Preferably, the microwave generator is configured for use whilst the mobile platform is stationary. For example, the system may comprise a power socket for connection to a source of electricity. The source of electricity may be provided by mains or grid electricity or via a generator or accumulator supplied by renewable energy (wind, solar etc) or via a battery pack. Additionally or alternatively, the microwave generator may be operable whilst the mobile platform is moving, for example the microwave generator may be supplied with electricity from a battery pack located on the mobile platform. For reasons of efficiency, it is preferred that the microwave generator is operated (or operable) whilst the mobile platform is stationary, for example during charging or re-fueling stops.

In embodiments, the sorbent may be a solid material. In embodiments, the sorbent may be a porous material. In embodiments, the sorbent may have low microwave absorption properties. In embodiments, the sorbent may comprise or consist of ceramic materials, for example zeolites. A commercially available form of zeolites is molecular sieve.

In embodiments, the sorbate may be a gaseous material when desorbed from the sorbent. In embodiments, the sorbate may be or comprise a liquid, for example water, for example a water/alcohol mixture. In embodiments, the sorbate may be or comprise an organic solvent, e.g. acetonitrile, acetone, methanol, ethanol, and/or ammonia.

In embodiments, the sorbent and sorbate pair may comprise molecular sieves and a water/alcohol mixture.

In embodiments, the system may comprise as the first chamber a first vessel. In embodiments, the sorbent may be located in the first chamber or vessel.

In embodiments, the system may comprise as the second chamber a second vessel. In use, for example during use of the mobile platform or system, the sorbate may be stored in the second vessel, separately from the sorbent, to store energy when the system is in use.

In embodiments, the first vessel and the second vessel may be connected, e.g. fluidly connected, by the conduit. In use, the sorbate vapour may travel from the second chamber or vessel to the first chamber or vessel along the conduit.

In embodiments, the system may comprise an auxiliary compressor to increase the rate of condensation or resorption of the sorbate onto the sorbent.

In embodiments, the system may comprise a means to rotate the reactor to increase the rate of condensation of sorbate and resorption of the sorbate onto the sorbent.

In embodiments, system comprises plural microwave generators.

In embodiments, the system of the invention may be used in electric vehicles, e.g. as a heating, ventilation, and cooling (HVAC) system for providing heating and air conditioning to the cabin of the vehicle, and may be also the electric battery packs. It is known that there is a reduction in driving range during operation in extreme environmental temperatures due to the need to keep the cabin at an ambient temperature. It is therefore advantageous to provide a secondary energy source, in addition to the electric car battery, for heating and cooling the ambient temperature of the vehicle, such that the driving range is not limited by the external temperature. More advantageously, the system may be charged using the same infrastructure as is used to charge the battery of an electric vehicle.

The storage system may comprise a flow means or pump for driving fluid into heat exchange relations with the energy storage system, in use. The flow means or pump may be energised by being operably connected to a source of power. The source of power may comprise an on-board battery pack.

The mobile platform may comprise a prime mover for locomotion and means to facilitate locomotion, such as rollers or wheels.

Alternatively, the system of the invention may be used for stationary uses, for example for domestic heating and/or cooling applications.

In embodiments, the system of the invention may also be used to make use of industrial waste heat, e.g. during the discharging process.

A further aspect of the invention provides a method for storing and releasing thermal energy, the method comprising providing a sorbent and sorbate pair and a microwave, using microwave energy to desorb the sorbate from the sorbent such that the sorbate condenses to store thermal energy, and subsequently evaporating the sorbate to cause the sorbate to resorb into and/or onto the sorbent to release thermal energy.

A yet further aspect of the invention provides a method of heating and/or cooling a mobile platform, the method comprising providing a mobile platform having means to allow the mobile platform to move on a roadway or the like and an energy storage system, the system comprising a sorbent and sorbate pair, the system further comprising a first chamber, a second chamber, a fluid flow conduit fluidly connecting the first chamber and the second chamber and a microwave generator, wherein the method comprises connecting the system to a source of power whilst the mobile platform is stationary and energising the microwave generator to desorb the sorbate from the sorbent in the first chamber to release thermal energy from the second chamber.

The method may further comprise storing the sorbate in the second chamber.

Any previously described features in relation to the system also apply to the method of the invention.

The method of the invention may be used in a charging process for a system to store energy by desorbing the sorbate from the sorbent. The method of the invention may be used in a discharging process to release energy by resorbing the sorbate into or onto the sorbent.

Advantageously, the use of a microwave energy enables the charging process to be instantly deployed. Excess electricity, e.g. during times of low demand, that may otherwise go to waste may be used for this process. Further, the use of microwave energy allows for system design to afford significant efficiency improvements, for example over thermal heating, not least because the sorbent/sorbate pair (or pairs if one or more sorbents and/or one or more sorbates are used) can be designed to take advantage of the properties of microwaves and the inherent characteristics of materials. For example, some materials are microwave transparent, whereas other materials are microwave absorbing.

Accordingly, in an embodiment, the sorbent is or may be preferably relatively microwave transparent compared to the sorbate and the sorbate is or may be relatively microwave absorbing compared to the sorbate. In this way microwave energy supplied by the microwave generator can be efficiently used by the sorbate, rather than heating the sorbent. As will be appreciated, some microwave absorption by the sorbent may facilitate thermal heating of the sorbate which may help to heat sorbate via a different mechanism. Accordingly, the materials of the sorbate may be chosen accordingly.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

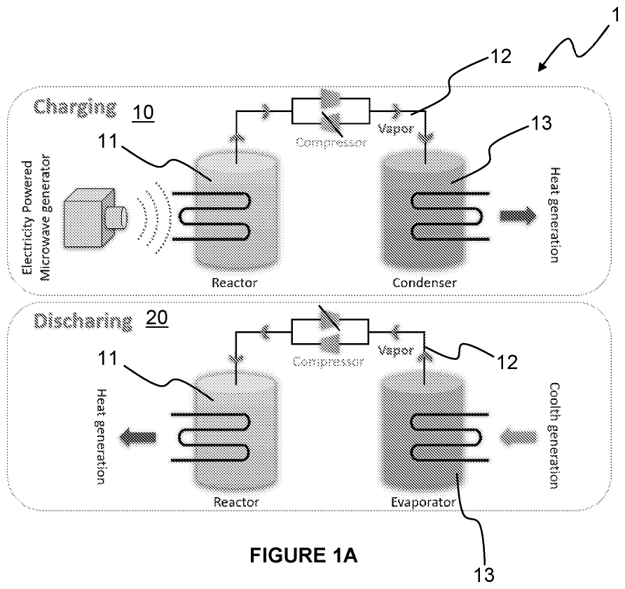

FIG. 1A is a schematic diagram of an energy storage and release system according to an embodiment of the invention;

FIG. 1B is a schematic diagram of a mobile platform including the energy storage and release system of FIG. 1;

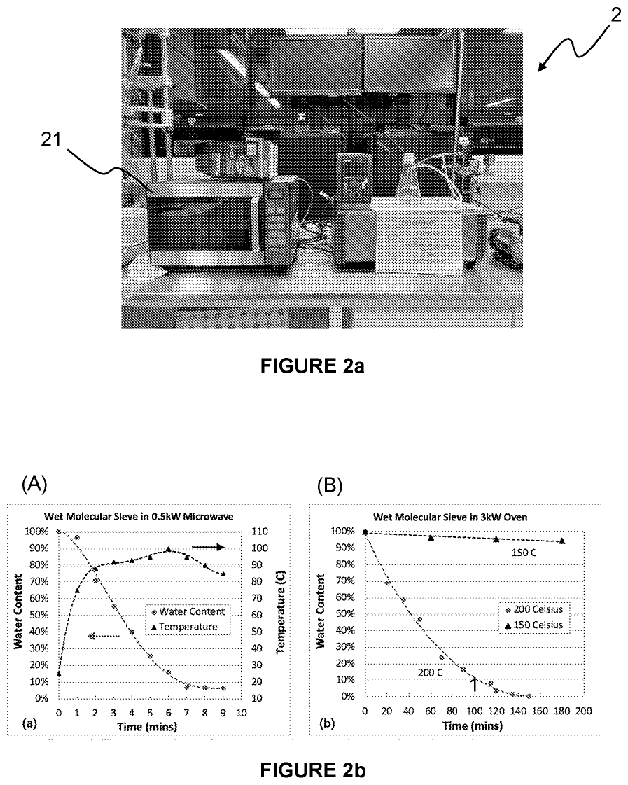

FIG. 2a is an experimental set up of the system according to the invention;

FIG. 2b illustrates the efficiency of the charging process (desorption) using molecular sieves and water as the sorbent/sorbate pair, when using a 0.5 kW microwave according to an Example of the invention, and a 3 kW oven according to a Comparative Example of the invention;

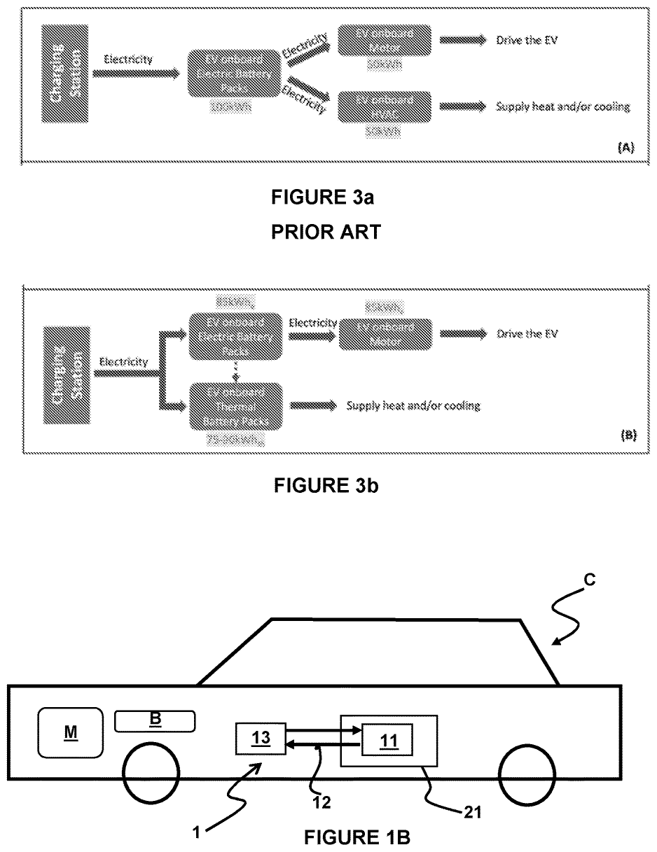

FIG. 3a is a flow diagram showing the process of charging and discharging an electric vehicle, according to the prior art; and

FIG. 3b is a flow diagram showing the process of charging and discharging an electric vehicle, wherein the electric vehicle comprises a battery according to the invention.

Referring now to FIG. 1A, there is shown an energy storage system 1 according to an embodiment of the invention. There is shown the energy storage system 1 in a charging process 10 and a discharging process 20.

The energy storage system 1 comprises a reactor 11, a conduit 12, and a vessel 13. The conduit 12 is located between and fluidly connected to the reactor 11 and the vessel 13. In a charging process, the vessel 13 functions as a condenser. In a discharging process, the vessel 13 functions as an evaporator.

In an initial state, the reactor 11 comprises a working pair of a solid sorbent and a sorbate.

The energy storage system 1 is an electrically driven, thermochemical-based system, which utilises reversible chemisorption or other types of reversible chemical reaction to store and release thermal energy.

In use, in the charging process 10, electricity powers a microwave generator to heat the sorbent located in the reactor 11. The sorbate is extracted from the sorbent in this process. This is an endothermic process. The sorbate vapour passes from the reactor 11, along the conduit 12, to the vessel 13 where it condenses into a liquid, thus providing a store of thermal energy which may be released on demand. In this way, energy is stored and/or transferred.

As will be appreciated, the microwave energy can be converted and released to an environment as heat energy.

During the discharging process 20, the liquid sorbate located in the vessel 13 is evaporated by absorbing thermal energy from the ambient surroundings. The sorbate vapour passes from the vessel 13, along the conduit 12, where it condenses and resorbs into or onto the sorbent. This is an exothermic process. In this way, energy is released.

As will be appreciated, because heat is absorbed from the environment the effect of vessel 13 is to cool the environment, while the effect of reactor 11 is to heat the environment.

Advantageously, the use of microwave energy enables the charging process 10 to be instantly deployed. Excess electricity, e.g. during times of low demand, that may otherwise go to waste may be used for this process.

More advantageously, the energy storage system 1 of the invention provides superior performance to those systems of the prior art. The system 1 provides higher electricity to heat conversion efficiency (COP) because heat is generated in both the charging and discharging process.

In embodiments, the energy storage system 1 may further comprise an auxiliary compressor to increase the rate of condensation and sorption during the charging and discharging processes respectively.

In embodiments, the energy storage system 1 may further comprise a means to rotate the reactor 11 to increase the rate of condensation and sorption during the charging and discharging processes respectively.

Additionally or alternatively, plural microwave generators may be used to provide consistent and/or substantially homogeneous irradiation of the reactor 11.

Such a system 1 may be deployed in a mobile platform such as a motor vehicle C, as shown in FIG. 1B. The motor vehicle C is provided with a battery pack B and an electric motor M usable to provide motive force to drive the wheels of the motor vehicle C.

Referring now to FIG. 2a, there is shown a “proof-of-concept” experimental set up 2 of the energy storage system according to the invention. There is shown a domestic microwave 21 (Maestrowave MW10 Microwave Oven, 0.5 kW power), which is used as the microwave generator in the energy storage system during the charging process.

The reactor was located in the microwave oven and the evaporator/condenser outside of the oven.

The charging process 10 and discharging process 20 as illustrated in FIG. 1 have been demonstrated using molecular sieves and water/alcohol mixtures as sorbent/sorbate pairs.

In this case the molecular sieve was 1/16 inch (1.6 mm) beads supplied by TRiiSO (MOLSIVE ADSORBENT Type 3A) and the water/alcohol mix was 1:0, 4:1, 2:1, and 1:1 (volume ratio). The mass fraction of molecular sieve to water/alcohol was 5:1 to 4:1.

Advantageously, molecular sieves are porous and have a large surface area for desorption and adsorption of the water/alcohol sorbate.

Referring now to FIG. 2b, there is shown two graphs comparing the efficiency of the charging process (desorption) using molecular sieves and water/alcohol mixtures as the sorbent/sorbate pair, when using a 0.5 kW microwave (A) according to an Example of the invention, and a 3 kW thermal oven (B) according to a Comparative Example of the invention.

Advantageously, the charging process (i.e. desorption of the water from the molecular sieves) was achieved in 7 minutes using microwave radiation, with a peak generated temperature of below 100° C., as shown in graph (A), the temperature being measured on the surface of the reactor inside the microwave oven. It is shown that the heat-driven charging process using an oven set at 200° C. took approximately 120 minutes. It is further shown that at 150° C. water is only sparingly desorbed, as shown in graph (B).

Therefore, it has been demonstrated that the microwave-driven charging process is more efficient than the heat-driven charging process.

Referring to Table 1, the sorbate need not be water or a water/alcohol mixture. Advantageously, the response time for the energy storage system during discharging may be halved by using non-aqueous sorbates, whilst the power density is doubled compared to aqueous sorbates.

TABLE 1
Vapour pressure of different sorbates (Unit: kPa)

| Temperature | Water | Acetonitrile | Acetone | Methanol | Ethanol | Ammonia |
|---|---|---|---|---|---|---|
| (° C.) | [H₂O] | [CH [symbol] CN] | [(CH [symbol] ) [symbol] CO] | [CH [symbol] OH] | [C [symbol] H [symbol] OH] | [NH₃] |
| 10 | 1.22 | 5.96 | 15.42 | | 3.11 | 614.9 |
| 20 | 2.33 | 9.67 | 24.57 | 12.98 | 5.83 | 857.1 |
| 40 | 7.36 | 23.05 | 56.25 | 35.39 | 17.83 | 1554 |
| 60 | 19.87 | 49.12 | 114.88 | 84.40 | 46.75 | 2613 |

[symbol]

indicates data missing or illegible when filed

It will be appreciated that molecular sieve (which is typically comprised of zeolites) is at least partially microwave transparent. This is beneficial because the microwave energy is then usable to do useful work on the sorbate.

Accordingly, the use of a porous, microwave transparent sorbent materials is beneficial and many suitable sorbent materials will be known to the skilled person, whether based on ceramics or other materials. It will also be appreciated that certain materials would not be suitable, for example graphene and other carbon materials which have high porosity (and are known to be useful sorbents) are generally unsuitable because of their absorption of microwave energy.

Further, sorbates which are not microwave transparent (other than those mentioned above such as water and/or alcohol) may be suitable candidates for the sorbate material. Suitable solid sorbents may be salts which are reversibly hydratable. For example, many salts have plural hydrated forms (e.g. MgSO₄·nH₂O) which can be reversibly accessed by cyclically dehydrating and re-hydrating the salt.

Referring now to FIG. 3a, there is shown a flow diagram (A) showing the process of charging and discharging an electric vehicle, according to the prior art. In the process of the prior art, electric vehicles have only a single primary energy source, i.e. the electric battery pack. This shares energy between the propulsion system and the heating, ventilation, and air conditioning (HVAC) system of the vehicle. The energy is supplied to the HVAC system via a simple resistive heating system or a complex heat pump. The energy supplied to the HVAC system typically reduces the driving range of the EV by up to 34% in summer and up to 54% in winter.

Accordingly, if the battery pack has a nominal output of, say 100 kWh, because the battery pack is used for HVAC and propulsion, the effective power for use by the propulsion system may be reduced to, say, 50 kWh.

Referring now to FIG. 3b, there is shown a flow diagram (B) showing the process of charging and discharging an electric vehicle, wherein the electric vehicle comprises a energy storage system according to the invention. The energy storage system is used for the HVAC system of the vehicle to provide heat or supply cooling air to the cabin. The only extra power demand is for a pump or flow means to move the cool or hot air for heat exchange with the energy storage system of the invention to provide the hot/cold air as a product of the energy storage system of the invention (assuming that the microwave generator is operated whilst the vehicle or mobile platform is stationary). Clearly, driving the fluid for heat exchange using a pump or other flow means requires much less energy (sourced from the EV battery pack) than driving a complete HVAC system, leading to the substantial gains high-lighted below.

The energy storage system of the invention has a high energy density, which is five to six times greater than that of an Li-ion electric battery, which are the most widely used in electric vehicles. Advantageously, the energy storage system of the invention may be used in tandem with the electric vehicle battery as a secondary energy source to meet heating and cooling demands required for cabin comfort and thermal management of the electric battery.

More advantageously, by replacing 15% by weight of the electric battery pack with the energy storage system of the invention would increase the driving range by up to 70% under unfavourable (hot/cold) climate conditions as the electrical energy available to drive the propulsion system would increase from 50 kWh to 85 kWh. The result is that with no added weight, the electric vehicle driving range becomes weather proof. Furthermore, the energy storge system of the invention is significantly more cost effective to produce than the standard electric vehicle battery and beneficially, the charging time for such a smaller vehicle battery is reduced whilst, counterintuitively, the range is extended.

Also, and as has been demonstrated above, the charging time for the energy storage system is significantly shorted than a typical EV charging cycle meaning that whilst the EV is docked for charging the energy storage system can be charged without exacerbating charging times.

Further, although the above demonstrates the benefit of reducing the size of the battery in concert with a thermal storage system, it is also possible to retain the battery size and use an energy storage system of the invention in concert to extend the driving range of the EV, not least because the EV battery pack is no longer required for HVAC functions. in rare occasions, if the energy storage system of the invention is fully discharged during driving, it can be alternatively charged by the onboard electric battery so that the heating/cooling demands can be met during driving.

Although there is clear utility and benefits with the use of energy storage of the invention in EVs, the energy storage system of the invention may also be used in other mobile platforms, for example refrigerated trolleys, trucks and other cold storage devices. Because the energy storage system is charged before use (for example at a garage, power station or other power source) there is no need for large on-board generators to drive cooling and heating systems.

It will also be appreciated by those skilled in the art that any number of combinations of the aforementioned features and/or those shown in the appended drawings provide clear advantages over the prior art and are therefore within the scope of the invention described herein.

1-2. (canceled)

3. An energy storage system, the system comprising a sorbent and sorbate pair, a first chamber, a second chamber, a fluid flow conduit fluidly connecting the first chamber and the second chamber, and a microwave generator, wherein the microwave generator is operable in use to desorb the sorbate from the sorbent in the first chamber to release thermal energy from the second chamber, and wherein the second chamber is thermally connectable to a source of fluid to condense the sorbate and thereby heat the fluid.

4. An energy storage system according to claim 3, wherein the sorbent is a solid material.

5. An energy storage system according to claim 3, wherein the sorbent is a porous material.

6. An energy storage system according to claim 3, wherein the sorbent has low microwave absorption properties.

7. An energy storage system according to claim 3, wherein the sorbent comprises ceramic materials.

8. (canceled)

9. An energy storage system according to claim 3, wherein the sorbate comprises one or more of water, a water/alcohol mixture, an organic solvent, or ammonia.

10-11. (canceled)

12. An energy storage system according to claim 3, wherein the system comprises as the first chamber a first vessel, wherein the system comprises as the second chamber a second vessel, and wherein the sorbate is stored in the second vessel, separately from the sorbent, to store energy when the system is in use.

13-14. (canceled)

15. An energy storage system according to claim 3, further comprising an auxiliary compressor to increase the rate of condensation or resorption of the sorbate onto the sorbent.

16. An energy storage system according to claim 3, further comprising a rotator to rotate the first chamber to increase the rate of condensation of sorbate and resorption of the sorbate onto the sorbent.

17. An energy storage system according to claim 3, wherein the microwave generator comprises plural microwave generators.

18. An energy storage system according to claim 3, further comprising a pump for driving fluid into heat exchange with the energy storage system.

19. A mobile platform comprising the energy storage system of claim 3.

20. A mobile platform according to claim 19, further comprising wheels and a prime mover for locomotion of the mobile platform.

21. A mobile platform according to claim 20, wherein the prime mover comprises a battery pack.

22. A method for storing and releasing thermal energy, the method comprising providing a sorbent and sorbate pair and a source of microwaves, using microwave energy from the source of microwaves to desorb the sorbate from the sorbent, condensing the sorbate within a flow conduit and subsequently condensing the sorbate to release thermal energy, and subsequently evaporating the sorbate to cause the sorbate to resorb into or onto the sorbent to release thermal energy.

23. A method according to claim 22, wherein subsequently condensing the sorbate to release thermal energy comprises condensing the sorbate within a second vessel and providing a second fluid in a heat exchange relationship with the condensed sorbate to harvest the released thermal energy.

24. A method according to claim 22, wherein evaporating the sorbate to cause the sorbate to resorb into or onto the sorbent comprises evaporating the sorbate within a first vessel and providing a first fluid in a heat exchange relationship with the resorbed sorbate to harvest the released thermal energy.

25. An energy storage system, the system comprising a sorbent and sorbate pair, a first chamber, a second chamber, a fluid flow conduit fluidly connecting the first chamber and the second chamber, a compressor located between the first chamber and second chamber to compress fluid within the fluid flow conduit, and a microwave generator, wherein the microwave generator is operable in use to desorb the sorbate from the sorbent in the first chamber to release thermal energy from the second chamber, wherein the compressor is operable to compress the sorbate, and wherein the second chamber is thermally connectable to a source of fluid to condense the sorbate and thereby heat the fluid.

26. An energy storage system according to claim 25, wherein the energy storage system is provided on a mobile platform comprising wheels, an electric motor, a battery pack for providing power to the electric motor to drive the wheels, and a heating, ventilation, and air conditioning (HVAC) system, wherein the HVAC comprises a first chamber, a second chamber, a fluid flow conduit fluidly connecting the first chamber and the second chamber, and a microwave generator, and wherein the microwave generator is operable in use to desorb the sorbate from the sorbent in the first chamber.

27. An energy storage system according to claim 26, wherein the microwave generator is operable while the mobile platform is stationary.
